(19) United States
(12) Patent Application Publication
(10) Pub. No.: US 2014/0283508 A1
(43) Pub. Date: Sep. 25, 2014

(54) DRIVE SYSTEM FOR HYDRAULIC CLOSED CIRCUIT

(71) Applicant: HITACHI CONSTRUCTION MACHINERY CO., LTD., Tokyo (JP)

(72) Inventors: Kenji Hiraku, Kasumigaura-shi (JP); Kazuo Fujishima, Tsuchiura-shi (JP)

(21) Appl. No.: 14/353,658

(22) PCT Filed: Dec. 3, 2012
(86) PCT No.: PCT/JP2012/081251

§ 371 Date: Apr. 23, 2014

(30) Foreign Application Priority Data
Jan. 11, 2012 (JP) 2012-003614

(51) Int. Cl. F15B 9/03

(52) U.S. Cl. CPC F15B 9/03
USPC 60/328

(57) ABSTRACT

A drive system suppresses cylinder speed fluctuation at times of load inversion in a hydraulic closed circuit system in which a single rod cylinder is driven by a hydraulic pump. The drive system has a control device including: pressure detection means which detect pressure in a rod-side hydraulic chamber of the hydraulic cylinder and pressure in a head-side hydraulic chamber of the hydraulic cylinder; load calculation means which calculates the load on the hydraulic cylinder from the pressure in the rod-side hydraulic chamber and the pressure in the head-side hydraulic chamber; load switching means which calculates a first proportional gain in accordance with the polarity of the calculated load; and multiplication means which calculates a command signal by multiplying the calculated first proportional gain and an operation amount input from the operating device together and outputs the calculated command signal to the delivery flow rate control means.

### TECHNICAL FIELD

The present invention relates to a drive system for a hydraulic closed circuit, and in particular, to a drive system for a hydraulic closed circuit that drives a hydraulic actuator directly with a hydraulic pump.

### BACKGROUND ART

In recent years, the energy saving has become one of the most important development items in the field of construction machines such as hydraulic excavators and wheel loaders. For the energy saving of a construction machine, it is essential to achieve energy saving of the hydraulic system itself. For this purpose, examinations have been made as to the employment of a hydraulic closed circuit system in which a hydraulic actuator is directly controlled by a hydraulic pump connected to the hydraulic actuator by means of closed circuit connection. This system is free from the pressure loss caused by control valves. No flow rate loss occurs since the pump flow (flow of the hydraulic fluid from the pump) is delivered only when necessary. Therefore, the energy saving is possible by the employment of such a hydraulic closed circuit system.

Since single rod cylinders are used as the hydraulic actuators in construction machines, it is necessary for achieving the closed circuit connection to absorb flow rate difference that is caused by the difference between the pressure-receiving areas on the head side and the rod side of the in-cylinder piston. Some methods for the absorption of the flow rate difference have been proposed.

For example, Patent Document 1 describes a configuration in which a low-pressure selection valve is arranged in an actuator circuit including a single rod cylinder and a hydraulic pump connected by means of the closed circuit connection. In response to the occurrence of surplus or insufficiency in the flow rate, the hydraulic fluid is automatically discharged from or drawn into the circuit into or from a tank via the low-pressure selection valve.

### PRIOR ART LITERATURE

### Patent Document

Patent Document 1: JP-2001-2371-A

### SUMMARY OF THE INVENTION

### Problem to be Solved by the Invention

The direction of the load on each hydraulic actuator (e.g., cylinder) frequently changes in construction machines different from devices like a hydraulic press in which the direction of the load is always constant. For example, in the arm cylinder of a hydraulic excavator, the weight of the arm in the extended state works in the direction of the cylinder being pulled, and thus the pressure in a rod-side hydraulic chamber becomes high. In a state in which the arm has been folded, the weight of the arm works in the direction of the cylinder pushed in reverse, and thus the pressure in a head-side hydraulic chamber becomes high. Similarly, in the boom cylinder, the weight of the boom positioned above the ground works in the direction of the cylinder being pushed, and thus the pressure in the head-side hydraulic chamber becomes high. When the boom takes the excavating position with the bucket contacting the ground, pulling force acts on the boom cylinder, and thus the pressure in the rod-side hydraulic chamber becomes high. It is desirable that, from the viewpoint of operability, the piston rod speed does not greatly fluctuate depending on the load while the usage status changes the cylinder load as above.

However, the piston rod speed fluctuates greatly when the direction of the load inverts, and consequently, the operability deteriorates in the hydraulic closed circuit system described in the Patent Document 1.

The object of the present invention, which has been made in consideration of the above-described situation, is to provide a drive system capable of improving the operability by suppressing the piston rod speed fluctuation at times of the load inversion in a hydraulic closed circuit system in which a single rod cylinder is driven by a hydraulic pump.

### Means for Solving the Problem

To achieve the above object, according to a first aspect of the present invention, there is provided a drive system for a hydraulic closed circuit that is equipped with: a bidirectional hydraulic pump; delivery flow rate control means which controls the delivery flow rate of the bidirectional hydraulic pump; a single rod cylinder which is driven by hydraulic fluid delivered from the bidirectional hydraulic pump; a first line having an end connected to one discharge port of the bidirectional hydraulic pump and the other end connected to a rod-side hydraulic chamber of the single rod cylinder; a second line having an end connected to the other discharge port of the bidirectional hydraulic pump and the other end connected to a head-side hydraulic chamber of the single rod cylinder; and an operating device for commanding the driving of the single rod cylinder. The drive system has: rod-side hydraulic chamber pressure detection means which detects the pressure in the rod-side hydraulic chamber of the single rod cylinder; head-side hydraulic chamber pressure detection means which detects the pressure in the head-side hydraulic chamber of the single rod cylinder; and a control device. The control device includes: load calculation means which calculates the load on the single rod cylinder on the basis of the pressure in the rod-side hydraulic chamber of the single rod cylinder detected by the rod-side hydraulic chamber pressure detection means and the pressure in the head-side hydraulic chamber of the single rod cylinder detected by the head-side hydraulic chamber pressure detection means; load switching means which calculates a first proportional gain according to the polarity of the load calculated by the load calculation means; and multiplication means which calculates a command signal by multiplying the first proportional gain calculated by the load switching means and an operation amount input from the operating device together and outputs the calculated command signal to the delivery flow rate control means.

According to a second aspect of the present invention, there is provided the drive system as described in the first aspect, wherein the load calculation means calculates the load on the single rod cylinder by subtracting the product of the pressure in the rod-side hydraulic chamber of the single rod cylinder detected by the rod-side hydraulic chamber pressure detection means and the pressure-receiving area on the cylinder rod side of the single rod cylinder from the product of the pressure in the head-side hydraulic chamber of the single rod cylinder detected by the head-side hydraulic chamber pressure detection means and the pressure-receiving area on the cylinder head side of the single rod cylinder.

According to a third aspect of the present invention, there is provided the drive system as described in the second aspect, wherein output characteristics of the first proportional gain output by the load switching means have a dead zone or hysteresis in a region where the polarity of the load on the single rod cylinder changes.

According to a fourth aspect of the present invention, there is provided the drive system as described in any of the first through third aspects, having a control device including: load sensing means which calculates a second proportional gain that gradually decreases with the increase in the load calculated by the load calculation means; and multiplication means which calculates a command signal by multiplying the first proportional gain calculated by the load switching means, the second proportional gain calculated by the load sensing means, and the operation amount input from the operating device together and outputs the calculated command signal to the delivery flow rate control means.

According to a fifth aspect of the present invention, there is provided a drive system for a hydraulic closed circuit that is equipped with: a plurality of bidirectional hydraulic pumps; a plurality of delivery flow rate control means which control the delivery flow rates of the bidirectional hydraulic pumps; a plurality of single rod cylinders which are driven by hydraulic fluid delivered from the bidirectional hydraulic pumps; a plurality of control valves which enable connection between either a rod-side hydraulic chamber or a head-side hydraulic chamber of one of the single rod cylinders and a discharge port of one or two of the bidirectional hydraulic pumps, and connection between the other of the rod-side hydraulic chamber or the head-side hydraulic chamber of the one of the single rod cylinders and the other discharge port of the one or two of the bidirectional hydraulic pumps; a plurality of operating devices for commanding the driving of the single rod cylinders. The drive system includes: rod-side hydraulic chamber pressure detection means which detects the pressure in the rod-side hydraulic chamber of each of the single rod cylinders; head-side hydraulic chamber pressure detection means which detects the pressure in the head-side hydraulic chamber of each of the single rod cylinders; and a control device. The control device has: load calculation means which calculates the load on each of the single rod cylinders on the basis of the pressure in the rod-side hydraulic chamber of each of the single rod cylinders detected by the rod-side hydraulic chamber pressure detection means and the pressure in the head-side hydraulic chamber of each of the single rod cylinders detected by the head-side hydraulic chamber pressure detection means; load switching means which calculates each first proportional gain according to the polarity of the load on each of the single rod cylinders calculated by the load calculation means; and multiplication means which calculates each command signal by multiplying each first proportional gain calculated by the load switching means and an operation amount input from each operating device together and outputs each calculated command signal to each delivery flow rate control means.

According to a sixth aspect of the present invention, there is provided the drive system as described in the fifth aspect, having a control device including: output limitation means which limits the output of the multiplication means to a preset command value and outputs the limited signal as the command signal to a delivery flow rate control means corresponding to one of the bidirectional hydraulic pumps; and subtraction means which subtracts the preset command value from the output of the multiplication means and outputs a signal calculated by the subtraction as the command signal to a delivery flow rate control means corresponding to another one of the bidirectional hydraulic pumps.

### Advantages

According to the present invention the piston rod speed fluctuation at times of the load inversion can be suppressed, which makes the fine control for better operability and controllability possible. This attributes to reduced vibrations and shocks due to the speed fluctuation, and satisfactory operability and comfortability provided with the operator. The productivity rises consequently.

### BRIEF DESCRIPTION OF THE DRAWINGS

FIG. 1 is a side view showing a hydraulic excavator equipped with a first embodiment of a drive system for a hydraulic closed circuit according to the present invention.

FIG. 2 is a hydraulic circuit diagram showing the first embodiment of the drive system for a hydraulic closed circuit according to the present invention.

FIG. 3 is a block diagram showing the contents of calculation by a controller constituting the first embodiment of the drive system for a hydraulic closed circuit according to the present invention.

FIG. 4 is a reference characteristic diagram showing an example of a relation between the servo pump flow rate, the cylinder pressure, the arm speed, and the arm displacement in the hydraulic closed circuit system when the arm cylinder is being driven.

FIG. 5 is a characteristic diagram showing an example of the relation between the servo pump flow rate, the cylinder pressure, the arm speed, and the arm displacement in the first embodiment of the drive system for a hydraulic closed circuit according to the present invention when the arm cylinder is being driven.

FIG. 6 is a hydraulic circuit diagram showing a second embodiment of the drive system for a hydraulic closed circuit according to the present invention.

FIG. 7 is a table showing examples of operations of solenoid control valves and servo pumps at times of circuit switching in the second embodiment of the drive system for a hydraulic closed circuit according to the present invention.

FIG. 8 is a block diagram showing the contents of calculation by a controller constituting the second embodiment of the drive system for a hydraulic closed circuit according to the present invention.

FIG. 9 is a characteristic diagram showing an example of the relation between the servo pump flow rates, the cylinder pressure, the arm speed, and the arm displacement in the second embodiment of the drive system for a hydraulic closed circuit according to the present invention when the arm cylinder is being driven.

FIG. 10 is a hydraulic circuit diagram showing a third embodiment of the drive system for a hydraulic closed circuit according to the present invention.

FIG. 11 is a hydraulic circuit diagram showing a fourth embodiment of the drive system for a hydraulic closed circuit according to the present invention.

### MODE FOR CARRYING OUT THE INVENTION

### First Embodiment

In the following, embodiments of a drive system for a hydraulic closed circuit according to the present invention will be described with reference to the figures.

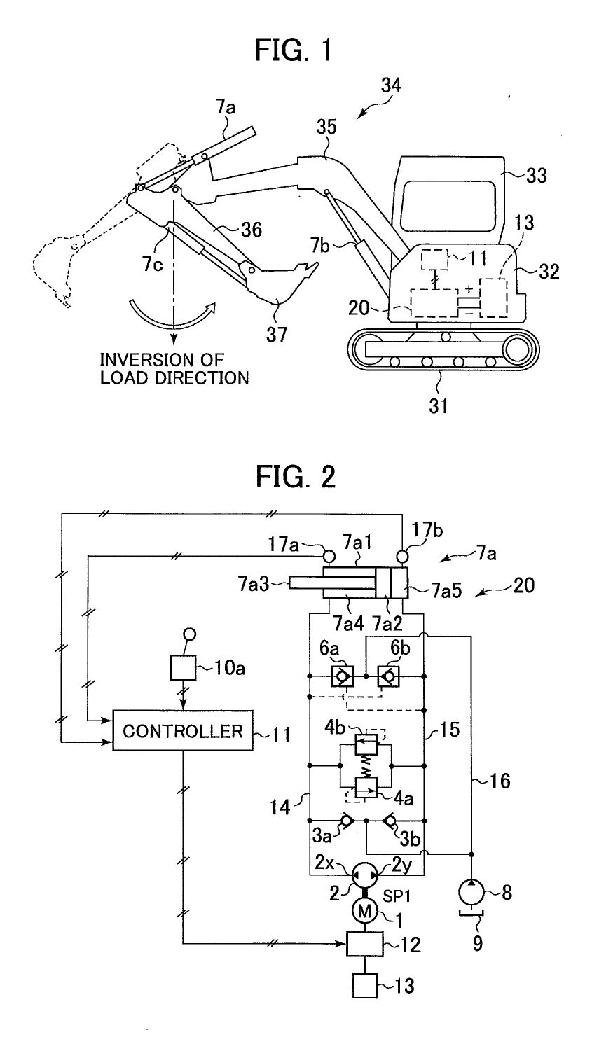

FIG. 1 is a side view showing a hydraulic excavator equipped with a first embodiment of the drive system for a hydraulic closed circuit according to the present invention. The hydraulic excavator in FIG. 1 includes a track structure 31, a swing structure 32 mounted on the track structure 31 swingably, a cab 33 arranged on the swing structure 32, and a multijoint front work implement 34 attached to a front part of the swing structure 32 rotatably (elevatably) in the vertical direction.

The swing structure 32 is furnished with a hydraulic closed circuit 20 whose details will be explained later, a battery 13 which supplies electric power to an inverter 12 (see FIG. 2) constituting the hydraulic closed circuit 20, and a controller 11 which controls the hydraulic closed circuit 20.

The front work implement 34 includes a boom 35 whose base end section is supported by the swing structure 32 to be rotatable around an axis, an arm 36 supported by the tip end part of the boom 35 to be rotatable around an axis, and a bucket 37 supported by the tip end of the arm 36 to be rotatable around an axis. The boom 35, the arm 36, and the bucket 37 are actuated by a boom hydraulic cylinder 7b, an arm hydraulic cylinder 7a, and a bucket hydraulic cylinder 7c, respectively.

Pressures in the rod-side hydraulic chamber and the head-side hydraulic chamber of the arm hydraulic cylinder 7a will be discussed below. In the state in which the arm 36 has been extended (indicated with dotted lines), the weight of the arm 36 works in the direction of the piston rod of the arm cylinder 7a being pulled; therefore, the pressure in the rod-side hydraulic chamber becomes high. In the state in which the arm 36 has been bent (indicated with solid lines), the weight of the arm 36 acts in the direction of the piston rod of the arm cylinder 7a being pushed; therefore, the pressure in the head-side hydraulic chamber becomes high.

In other words, the direction of the load on the arm cylinder 7a inverts depending on whether the axial direction of the rotating arm 36 exceeds the substantially perpendicular line (indicated with a chain line) extending downward from the center of the shaft, which supports the arm 36, of the tip end part of the boom 35.

The hydraulic closed circuit 20 will now be explained below with reference to FIG. 2 which is a hydraulic circuit diagram showing the first embodiment of the drive system for a hydraulic closed circuit according to the present invention. An example for driving the arm cylinder 7a of the hydraulic excavator is illustrated in this embodiment. Reference characters in FIG. 2 identical to those in FIG. 1 represent components identical to those in FIG. 1, and thus detailed explanation thereof is omitted here.

In FIG. 2, the reference character 1 represents an electric motor, 2 represents a bidirectional hydraulic pump, 3a and 3b represent first and second check valves, 4a and 4b represent first and second relief valves, 6a and 6b represent first and second pilot check valves, 7a represents the arm cylinder, 8 represents a low-pressure pump, 9 represents a tank, 10a represents an arm control lever, 11 represents the controller, 12 represents the inverter, and 13 represents the battery. The electric motor 1 is driven and rotated by the electric power supplied from the battery 13 via the inverter 12 functioning as delivery flow rate control means. The inverter 12 supplies the electric motor 1 with electric power corresponding to a drive torque command input from the controller 11. The rotating shaft of the electric motor 1 is mechanically connected to the rotating shaft of the bidirectional hydraulic pump 2. Rotation of the hydraulic pump 2 in the normal and reverse directions inverts the intake and discharge directions of the hydraulic fluid and reciprocates the arm cylinder 7a. The combination of the electric motor 1 and the hydraulic pump 2 will hereinafter be referred to as a “servo pump SP1.”

The arm cylinder 7a includes a cylinder body 7a1, piston 7a2 arranged in the cylinder body 7a1 to be movable, and a piston rod 7a3 arranged on one side of the piston 7a2. A single rod cylinder having a rod-side hydraulic chamber 7a4 and a head-side hydraulic chamber 7a5 is formed with these components.

The low-pressure pump 8 draws in the hydraulic fluid from the tank 9 and supplies low-pressure hydraulic fluid to a delivery line (low-pressure line) 16. The delivery line 16 is connected to the inlet side of the first and second pilot check valves 6a and 6b and to the inlet side of the first and second check valves 3a and 3b.

The hydraulic pump 2 has two hydraulic fluid discharge and intake ports 2x and 2y. A first line 14 has one end connected to one hydraulic fluid discharge and intake port 2x. The other end of the first line 14 is connected to a connection port of the rod-side hydraulic chamber 7a4 of the arm cylinder 7a. A second line 15 has one end connected to the other hydraulic fluid discharge and intake port 2y. The other end of the second line 15 is connected to a connection port of the head-side hydraulic chamber 7a5 of the arm cylinder 7a.

The outlet side of the first check valve 3a, allowing the intake only, and the outlet side of the first pilot check valve 6a, allowing the intake only using the pressure in the second line 15 as the pilot pressure, are connected to the first line 14. The inlet side of the first check valve 3a and the inlet side of the first pilot check valve 6a are connected to lines communicating with the delivery line 16 of the low-pressure pump 8.

The outlet side of the second check valve 3b, allowing the intake only, and the outlet side of the second pilot check valve 6b, allowing the intake only using the pressure in the first line 14 as the pilot pressure, are connected to the second line 15. The inlet side of the second check valve 3b and the inlet side of the second pilot check valve 6b are connected to the lines communicating with the delivery line 16 of the low-pressure pump 8.

The inlet side of the first relief valve 4a which releases the hydraulic fluid to the second line 15 when the pressure in the first line 14 reaches a preset pressure or higher is further connected to the first line 14. The outlet side of the first relief valve 4a communicates with the second line 15. Similarly, the inlet side of the second relief valve 4b which releases the hydraulic fluid to the first line 14 when the pressure in the second line 15 reaches a preset pressure or higher is connected to the second line 15. The outlet side of the second relief valve 4b is attached to the first line 14. The first and second relief valves 4a and 4b are used for preventing damages to the pumps and the lines.

The first and second check valves 3a and 3b are valves for inhibiting the occurrence of the cavitation in the circuit by drawing in the hydraulic fluid, delivered from the low-pressure pump 8, from the low-pressure line 16 when the pressure in the circuit (pressure in the first line 14 or the second line 15) drops.

The first and second pilot check valves 6a and 6b are for discharging the hydraulic fluid from the circuit to the low-pressure line 16 or drawing in the hydraulic fluid from the low-pressure line 16 to the circuit in order to compensate for the flow rate difference caused by the reciprocating motion of the arm cylinder 7a as a single rod cylinder.

A part of the cylinder body 7a1 on the rod side of the arm cylinder 7a is provided with a first pressure sensor 17a (rod-side hydraulic chamber pressure detection means) for detecting the pressure in the rod-side hydraulic chamber 7a4. A part of the cylinder body 7a1 on the head side of the arm cylinder 7a is equipped with a second pressure sensor 17b (head-side hydraulic chamber pressure detection means) for detecting the pressure in the head-side hydraulic chamber 7a5. The pressures in the hydraulic chambers detected by the first and second pressure sensors 17a and 17b are input to the controller 11.

The arm control lever 10a is arranged in the cab 33. An operation amount signal from the arm control lever 10a is input to the controller 11. The controller 11 calculates a revolution speed command for the electric motor 1 and the hydraulic pump 2 on the basis of the operation amount signal, the signals from the first and second pressure sensors 17a and 17b, and others to output a drive command signal to the inverter 12.

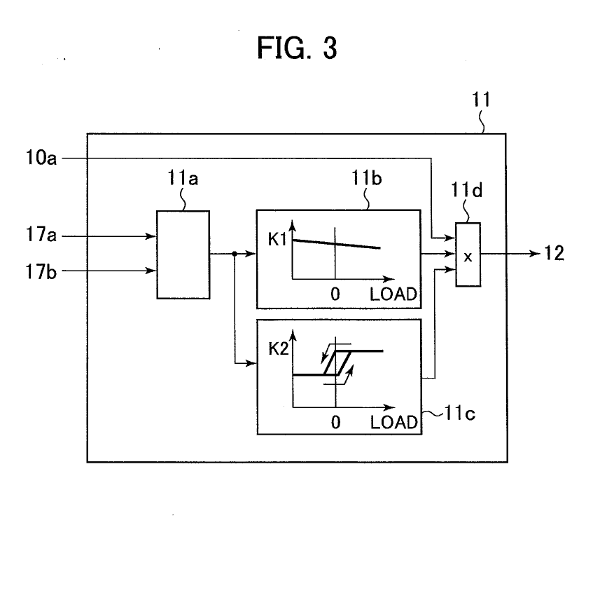

The contents of the calculation of the drive command signal performed by the controller 11 will now be explained below with reference to FIG. 3. FIG. 3 is a block diagram showing the contents of the calculation by the controller constituting the first embodiment of the drive system for a hydraulic closed circuit according to the present invention. Reference characters in FIG. 3 identical to those in FIGS. 1 and 2 represent components identical to those in FIGS. 1 and 2, and thus detailed explanation thereof is omitted here.

As shown in FIG. 3, the controller 11 includes load calculation means 11a, load sensing means 11b, load switching means 11c, and multiplication means 11d. Input to the controller 11 are the operation amount signal from the arm control lever 10a, the pressure in the rod-side hydraulic chamber 7a4 of the arm cylinder 7a detected by the first pressure sensor 17a, and the pressure in the head-side hydraulic chamber 7a5 of the arm cylinder 7a detected by the second pressure sensor 17b. The controller 11 outputs the command signal for driving the servo pump SP1 to the inverter 12.

The pressure in the rod-side hydraulic chamber 7a4 of the arm cylinder 7a detected by the first pressure sensor 17a and the pressure in the head-side hydraulic chamber 7a5 of the arm cylinder 7a detected by the second pressure sensor 17b are input to the load calculation means 11a. The load calculation means 11a calculates the cylinder load F on the arm cylinder 7a in accordance with the following expression (1):

F=Phead×Ahead−Prod×Arod (1)

where “Phead” represents the pressure in the head-side hydraulic chamber 7a5 of the arm cylinder 7a detected by the second pressure sensor 17b, “Ahead” represents the pressure-receiving area on the head side of the piston 7a2 in the arm cylinder 7a, “Prod” represents the pressure in the rod-side hydraulic chamber 7a4 of the arm cylinder 7a detected by the first pressure sensor 17a, and “Arod” represents the pressure-receiving area on the rod side of the piston 7a2 in the arm cylinder 7a. A signal of the calculated cylinder load F is output to the load sensing means 11b and the load switching means 11c.

The signal of the cylinder load F is input to the load sensing means 11b. The load sensing means 11b calculates a gain constant K1 in accordance with pre-determined characteristics of the gain constant K1 with respect to the cylinder load F. The characteristics are configured such that the increase in the cylinder load F decreases the gain constant K1 gradually as shown in FIG. 3. For example, the gain constant K1 equals 1 when the cylinder load F is 0. The gain constant K1 takes on its maximum value when the cylinder load F is at the minimum. The gain constant K1 is greater than 1 when the cylinder load F is on the negative side. The gain constant K1 is less than 1 when the cylinder load F is on the positive side. The gain constant K1 takes on its minimum value when the cylinder load F is at the maximum. A signal of the calculated gain constant K1 is output to the multiplication means 11d.

The signal of the cylinder load F is input to the load switching means 11c. The load switching means 11c calculates a gain constant K2 in accordance with preset characteristics of the gain constant K2 with respect to the cylinder load F. The characteristics is configured as shown in FIG. 3 such that the gain constant K2 changes by the ratio of the pressure-receiving area (Ahead) on the head side of the piston 7a2 in the arm cylinder 7a to the pressure-receiving area (Arod) on the rod side of the piston 7a2 in the arm cylinder 7a depending on the direction of the cylinder load F. For example, it is assumed that the gain constant K2 equals 1 when the cylinder load F is on the negative side. When the cylinder load F is on the positive side, the gain constant K2 equals, for example, 1.3 as the ratio of the pressure-receiving area (Ahead) on the head side of the piston 7a2 in the arm cylinder 7a to the pressure-receiving area (Arod) on the rod side of the piston 7a2 in the arm cylinder 7a. A signal of the calculated gain constant K2 is output to the multiplication means 11d.

The switching characteristics of the gain constant K2 are configured to have the dead zone and the hysteresis shown in FIG. 3. Such settings prevent frequent occurrence of the switching due to minute pressure pulsations and sensor noise to thereby avert the hunting and vibration. Since there is a delay between the change of the direction of the cylinder load F and the opening/closing action of the pilot check valves 6a and 6b functioning as low-pressure selection valves, the switching characteristics are configured such that the gain constant K2 is shifted after the pilot check valves 6a and 6b has been switched in a secure manner and the pressure has risen to a certain level. Inclination is further given to the switching of the gain constant K2 in such a manner that the gain constant changes smoothly. With such settings the flow rate of the hydraulic pump 2 switches smoothly and the shock to the arm cylinder 7a is reduced, which consequently achieves high operability.

The operation amount signal from the arm control lever 10a, the gain constant K1 as the output of the load sensing means 11b, and the gain constant K2 as the output of the load switching means 11c are input to the multiplication means 11d. The multiplication means 11d calculates a torque command for the electric motor 1 by multiplying the input values together. The calculated torque command for the electric motor 1 is output to the inverter 12. The inverter 12 controls the revolution speed of the electric motor 1 and the hydraulic pump 2 (i.e., the servo pump SP1) on the basis of the torque command.

Since the drive command for the servo pump SP1 is output after the multiplication of the operation amount signal from the arm control lever 10a by the gain constants K1 and K2 as explained above, the flow rate of the hydraulic pump 2 can be controlled in accordance with the magnitude and the direction of the cylinder load F.

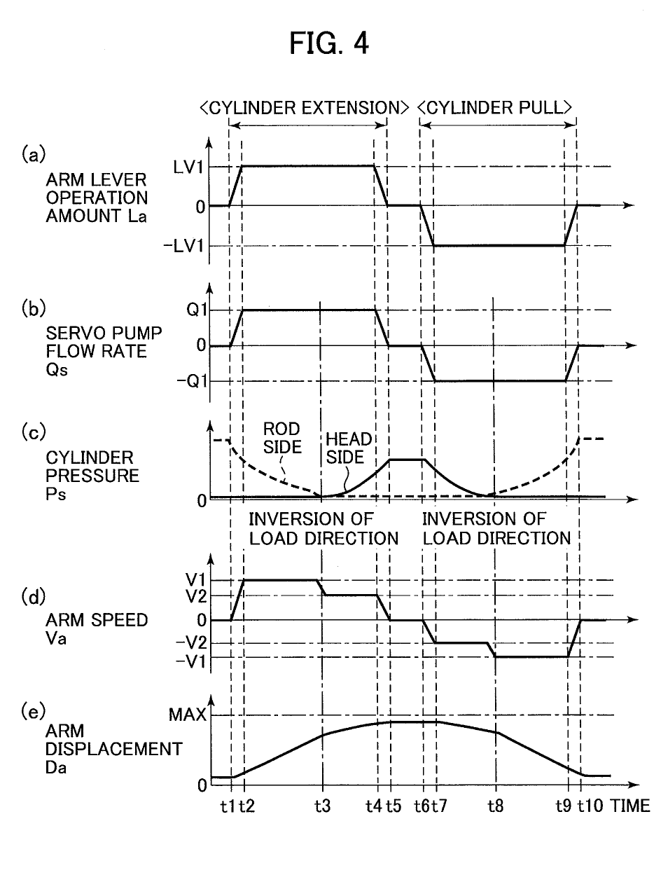

The influence of the cylinder load on the cylinder speed in the hydraulic closed circuit system will now be explained below with reference to FIG. 4. FIG. 4 is a reference characteristic diagram showing an example of the relation between the servo pump flow rate, the cylinder pressure, the arm speed, and the arm displacement in the hydraulic closed circuit system when the arm cylinder is being driven. In order to clearly indicate the features of this embodiment, FIG. 4 shows an example of the operation of the arm cylinder 7a in a case where both the gain constant K1, the output of the load sensing means 11b, and the gain constant K2, the output of the load switching means 11c, in FIG. 3 are set at a fixed value “1.”

In FIG. 4, the horizontal axis represents the time and the vertical axes (a)-(e) show (from top to bottom) the arm lever operation mount La, the servo pump flow rate Qs, the arm cylinder pressure Ps, the arm speed Va, and the arm displacement Da. The graphs from time t1 to time t5 indicate the above characteristics during the extension operation of the piston rod 7a3 in the arm cylinder 7a, while the graphs from time t6 to time t10 imply the above characteristics during the pull operation of the piston rod 7a3 in the arm cylinder 7a.

First, the extension operation of the piston rod 7a3 will be explained below. With reference back to FIG. 1, the initial status of the arm 36 in the hydraulic excavator is assumed to be the extended state indicated with the dotted lines. The weight of the arm 36 works in the direction of the piston rod 7a3 of the arm cylinder 7a being pulled in this status. Therefore, the pressure in the rod-side hydraulic chamber 7a4 is high and the pressure in the head-side hydraulic chamber 7a5 is low.

At the time t1, the operator starts operating the arm control lever 10a in the direction of the piston rod 7a3 being extended. The operator uses the arm control lever 10a for an operation amount LV1 by the time t2. In this case, a flow Q1 of the hydraulic fluid (as the hydraulic fluid flow rate Qs proportional to the operation amount) is delivered from the servo pump SP1, the hydraulic fluid flows into the head-side hydraulic chamber 7a5 of the arm cylinder 7a, and the piston rod 7a3 in the arm cylinder 7a starts the extension operation.

Since the rod-side hydraulic chamber 7a4 is at high pressures in FIG. 2 at this time, the first check valve 3a and the first pilot check valve 6a connected to the first line 14 get closed and the entire flow of the hydraulic fluid from the rod-side hydraulic chamber 7a4 is drawn into the hydraulic fluid discharge and intake port 2x of the hydraulic pump 2. At this point, the flow rate becomes insufficient as the intake flow rate of the hydraulic pump 2 is lower than the required delivery flow rate of the hydraulic pump 2 due to the capacity difference between the cylinder head-side hydraulic chamber 7a5 and the cylinder rod-side hydraulic chamber 7a4. However, the shortfall of the hydraulic fluid flow is supplied from the low-pressure pump 8 via the low-pressure line 16 and is drawn into the second line 15 by the release operation with the pilot check valve 6b and the check valve 3b.

The speed V1 of the piston rod 7a3 in the arm cylinder 7a at this time can be calculated according to the following expression (2):

V1=Q1÷Arod (2)

where “Q1” represents the servo pump flow rate Qs (in this case, the intake flow rate) and “Arod” shows the pressure-receiving area on the rod side of the piston 7a2 in the arm cylinder 7a.

Due to the above-described extension of the piston rod 7a3 in the arm cylinder 7a, the arm 36 rotates downward, and accordingly, the pressure in the cylinder rod-side hydraulic chamber 7a4 decreases. At the point (time t3) when the axial direction of the arm 36 exceeds the substantially perpendicular line extending downward from the center of the axis of the tip end part of the boom 35 supporting the arm 36, the direction of the cylinder load F on the arm cylinder 7a inverts. In other words, the pressure in the cylinder head-side hydraulic chamber 7a5 becomes high and the pressure in the cylinder rod-side hydraulic chamber 7a4 becomes low. The operator holds the arm control lever 10a at the operation amount LV1 till the time t4 and then returns the operation amount to 0 in the period from the time t4 to the time t5.

Since the head-side hydraulic chamber 7a5 is at high pressures in FIG. 2 at this time (between the time t3 and the time t4), the second check valve 3b and the second pilot check valve 6b connected to the second line 15 get closed and the entire flow Qs of the hydraulic fluid delivered from the servo pump SP1 flows into the cylinder head-side hydraulic chamber 7a5. At this point, the flow rate becomes insufficient as the intake flow rate of the hydraulic pump 2 is lower than the required delivery flow rate of the hydraulic pump 2 due to the capacity difference between the cylinder head-side hydraulic chamber 7a5 and the cylinder rod-side hydraulic chamber 7a4. However, the shortfall of the hydraulic fluid flow is supplied from the low-pressure pump 8 via the low-pressure line 16 and is drawn into the first line 14 by the release operation with the pilot check valve 6a and the check valve 3a. Consequently, the insufficiency of the flow rate is compensated for.

The speed V2 of the piston rod 7a3 in the arm cylinder 7a at this time can be calculated according to the following expression (3):

V2=Q1÷Ahead (3)

where “Q1” represents the servo pump flow rate Qs (in this case, the delivery flow rate) and “Ahead” shows the pressure-receiving area on the head side of the piston 7a2 in the arm cylinder 7a.

As is clear from the above expressions (2) and (3), even when the flow rate Qs of the servo pump SP1 remains constant at Q1, the speed of the piston rod 7a3 in the arm cylinder 7a changes from V1 to V2 by the ratio of the pressure-receiving area on the rod side of the piston 7a2 to the pressure-receiving area on the head side of the piston 7a2 due to the inversion of the direction of the cylinder load F. The ratio of the pressure-receiving area on the rod side of the piston to the pressure-receiving area on the head side of the piston is approximately 0.5-0.7 in hydraulic cylinders used for construction machines in general. Therefore, the speed of the piston rod changes by approximately 30-50% and that can lead to deterioration in the operability. Further, the sharp change in the speed of the piston rod causes a strong shock to the vehicle body and that can deteriorate the comfortability.

Although detailed explanation is omitted here, also in the pull operation of the piston rod 7a3 in the arm cylinder 7a (from the time t6 to the time t10), the speed of the piston rod 7a3 in the arm cylinder 7a changes from −V2 to −V1 due to the inversion of the cylinder load F similarly to the above-described extension operation of the piston rod 7a3 in the arm cylinder 7a. The change in the speed of the piston rod can bring about the lower operability as well.

The speed of the piston rod 7a3 in the arm cylinder 7a remains constant except at times of the inversion of the cylinder load F as shown in FIG. 4. This is because the speed of a piston rod in a hydraulic closed circuit is dependent on the flow rate of the hydraulic pump 2 and is basically not affected by the load pressure. This attribute is desirable from the viewpoint of load robustness and is advantageous especially when high-precision drive control is required.

However, that characteristic can give a sense of strangeness to operators accustomed to the operation of hydraulic excavators equipped with a hydraulic circuit of the ordinary valve control type. In such a valve control-type hydraulic circuit, the flow rate of the hydraulic fluid to the cylinder is controlled by restriction of the port diameter of the control valve. The increase in the cylinder load F decreases the differential pressure in the control valve and the flow rate of the hydraulic fluid, which results in the lower speed of the piston rod. For example, when a hydraulic cylinder encounters resistance in an excavation operation by the hydraulic excavator, the piston rod speed declines in such a valve control-type hydraulic circuit, which in turn gives a natural operational feeling to the operator. In contrast, the piston rod speed does not change even when the hydraulic cylinder meets resistance in the hydraulic closed circuit. That can provide strangeness in the operational feeling with the operator.

To solve such a problem, the calculation of the gain constant K1 by the load sensing means 11b shown in FIG. 3 is performed in this embodiment so as to gradually decrease the gain constant K1 in proportion to the increase in the cylinder load F. This allows the piston rod speed to decline as the cylinder load F rises. Further, the gain constant K2 changes by the ratio of the pressure-receiving area (Ahead) on the head side of the piston 7a2 in the arm cylinder 7a to the pressure-receiving area (Arod) on the rod side of the piston 7a2 in the arm cylinder 7a at the time of the calculation of the gain constant K2 by the load switching means 11c shown in FIG. 3.

Assuming that the gain constant K2 in the zone where the rod-side hydraulic chamber 7a4 is at higher pressure than the head-side hydraulic chamber 7a5 is 1, for example, and the ratio of the pressure-receiving area (Ahead) on the head side of the piston 7a2 in the arm cylinder 7a to the pressure-receiving area (Arod) on the rod side of the piston 7a2 in the arm cylinder 7a is 1.3, for example, the gain constant K2 is raised to 1.3 in the area where the head-side hydraulic chamber 7a5 is at higher pressure than the rod-side hydraulic chamber 7a4. This increases the hydraulic fluid flow rate of the servo pump SP1 in the zone where the head-side hydraulic chamber 7a5 is at higher pressure than the rod-side hydraulic chamber 7a4. The aforementioned drop in the cylinder speed can be prevented consequently.

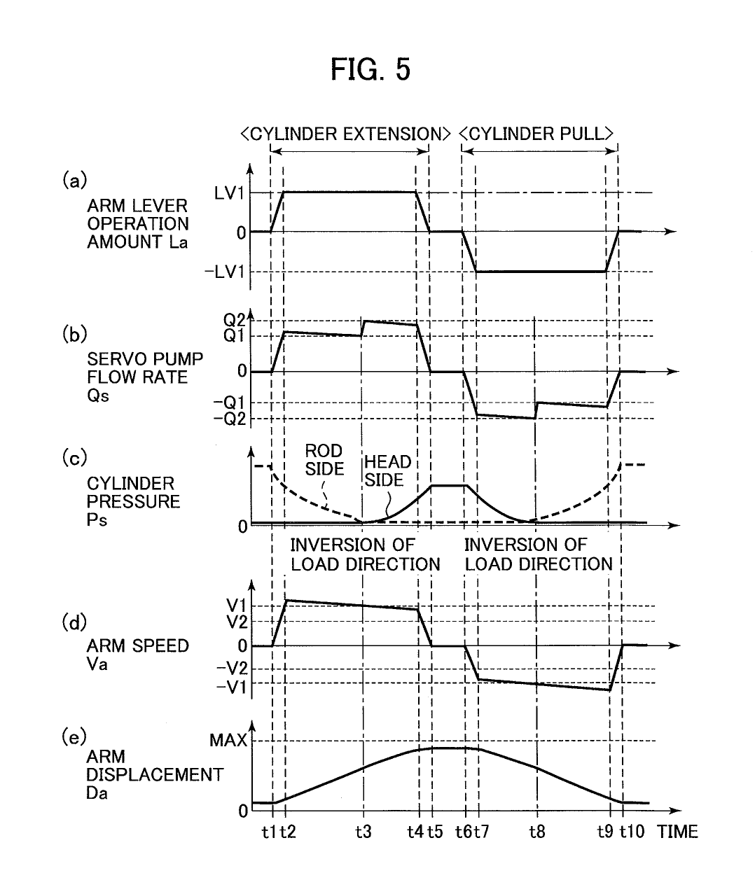

The operation of the first embodiment of the drive system for a hydraulic closed circuit according to the present invention will now be described below with reference to FIG. 5. FIG. 5 is a characteristic diagram showing an example of the relation between the servo pump flow rate, the cylinder pressure, the arm speed, and the arm displacement in the first embodiment of the drive system for a hydraulic closed circuit according to the present invention when the arm cylinder is being driven.

In FIG. 5, the horizontal axis represents the time and the vertical axes (a)-(e) represent from top to bottom the arm lever operation mount La, the servo pump flow rate Qs, the arm cylinder pressure Ps, the arm speed Va, and the arm displacement Da. The graphs from time t1 to time t5 indicate the above characteristics during the extension operation of the piston rod 7a3 in the arm cylinder 7a, while the graphs from time t6 to time t10 imply the characteristics during the pull operation of the piston rod 7a3 in the arm cylinder 7a.

First, the extension operation of the piston rod 7a3 will be explained below. With reference back to FIG. 1, the initial status of the arm 36 in the hydraulic excavator is assumed to be the extended one indicated with the dotted lines. In this status, the weight of the arm 36 works in the direction of the piston rod 7a3 of the arm cylinder 7a being pulled. Therefore, the pressure in the rod-side hydraulic chamber 7a4 is high and the pressure in the head-side hydraulic chamber 7a5 is low.

At the time t1, the operator starts using the arm control lever 10a in the direction of the piston rod 7a3 being extended. The operator handles the arm control lever 10a for an operation amount LV1 by the time t2. In this case, the load sensing means 11b in FIG. 3 outputs a value 1 or greater as the gain constant K1 and the load switching means 11c outputs a value 1 as the gain constant K2. Accordingly, a flow Qs (Q1 or higher) of the hydraulic fluid (Qs: product of the operation amount, the gain constant K1, and the gain constant K2) is delivered from the servo pump SP1, the hydraulic fluid flows into the head-side hydraulic chamber 7a5 of the arm cylinder 7a, and the piston rod 7a3 in the arm cylinder 7a starts the extension operation.

The operation of the hydraulic closed circuit shown in FIG. 2 is similar to that in FIG. 4. However, the speed of the piston rod 7a3 in the arm cylinder 7a is V1 or higher since the flow rate of the hydraulic fluid is Q1 or more. The arm 36 rotates downward due to the above-described extension of the piston rod 7a3 in the arm cylinder 7a. At the time (time t3) when the axial direction of the arm 36 exceeds the substantially perpendicular line extending downward from the center of the axis of the tip end part of the boom 35 supporting the arm 36, the direction of the cylinder load F on the arm cylinder 7a inverts. The gain constant K1 equals 1 at the time t3 because of the characteristics of the load sensing means 11b shown in FIG. 3. The flow rate Qs of the hydraulic fluid equals Q1 and the speed of the piston rod 7a3 in the arm cylinder 7a equals V1 at the time t3. The operator holds the arm control lever 10a at the operation amount LV1 till the time t4 and then returns the operation amount to 0 during the period from the time t4 to the time t5.

Between the time t3 and the time t4, the operation of the hydraulic closed circuit shown in FIG. 2 is similar to that in FIG. 4. However, the load switching means 11c shown in FIG. 3 outputs a value 1.3, for example, as the gain constant K2 due to the inversion of the direction of the cylinder load F. Accordingly, a flow Qs (Q2) of the hydraulic fluid (Qs: product of the operation amount, the gain constant K1, and the gain constant K2) is delivered from the servo pump SP1, the hydraulic fluid flows into the head-side hydraulic chamber 7a5 of the arm cylinder 7a, and the piston rod 7a3 in the arm cylinder 7a continues the extension operation. In other words, the increase in the flow rate Qs of the servo pump SP1 inhibits the drop in the speed of the piston rod 7a3 in the arm cylinder 7a, compared to the speed prior to the load direction inversion. The flow rate QS of the servo pump SP1 at the time t3 is Q2 and that at the time t4 is lower than Q2, which attributes to the characteristics of the load sensing means 11b.

A sharp change in the arm speed is averted with the increase in the flow rate Qs of the servo pump SP1 from Q1 to Q2 at the time of the load direction inversion as explained above. The flow rate (Q2) of the hydraulic fluid increases from Q1 by the ratio between the pressure-receiving areas in the cylinder. In other words, the flow rate Q2 is determined as Q2=Q1*Ahead/Arod. The use of the load sensing means 11b raises the pressure in the head-side hydraulic chamber 7a5, as well as the cylinder load F. This causes the reduction in the flow rate Qs of the servo pumps SP1, which leads to the lower arm speed. The natural operational feeling can be thereby realized as a result of the speed degradation. The natural operational feeling can be obtained by the reduction in the flow rate Qs of the servo pump SP1 by use of the load sensing means 11b. When the pressure in the head-side hydraulic chamber 7a5 has risen, the cylinder load F becomes higher as well, whereby the flow rate Qs as above is accompanied to be lessened.

The load sensing means 11b and the load switching means 11c control the pull operation of the piston rod 7a3. As a consequence, the speed of the piston rod 7a3 in the arm cylinder 7a in accordance with the cylinder load F can be made smooth similarly without the speed fluctuation at times of the load inversion.

In the above-described first embodiment of the drive system for a hydraulic closed circuit according to the present invention, the speed fluctuation of the piston rod 7a3 at times of the load inversion can be suppressed, which achieves the fine control and improves operability and controllability. This accomplishment makes it possible to reduce vibrations and shocks due to the speed fluctuation and provide satisfactory operability and comfortability with the operator. The productivity consequently is enhanced.

Further in the above-described first embodiment of the drive system for a hydraulic closed circuit in the present invention, the speed of the piston rod 7a3 can be reduced in accordance with the cylinder load F. Therefore, operational feeling equivalent to that of standard construction and work machines can be achieved and high operability without sense of strangeness can be provided with operators accustomed to the standard machines. The productivity consequently advances.

### Second Embodiment

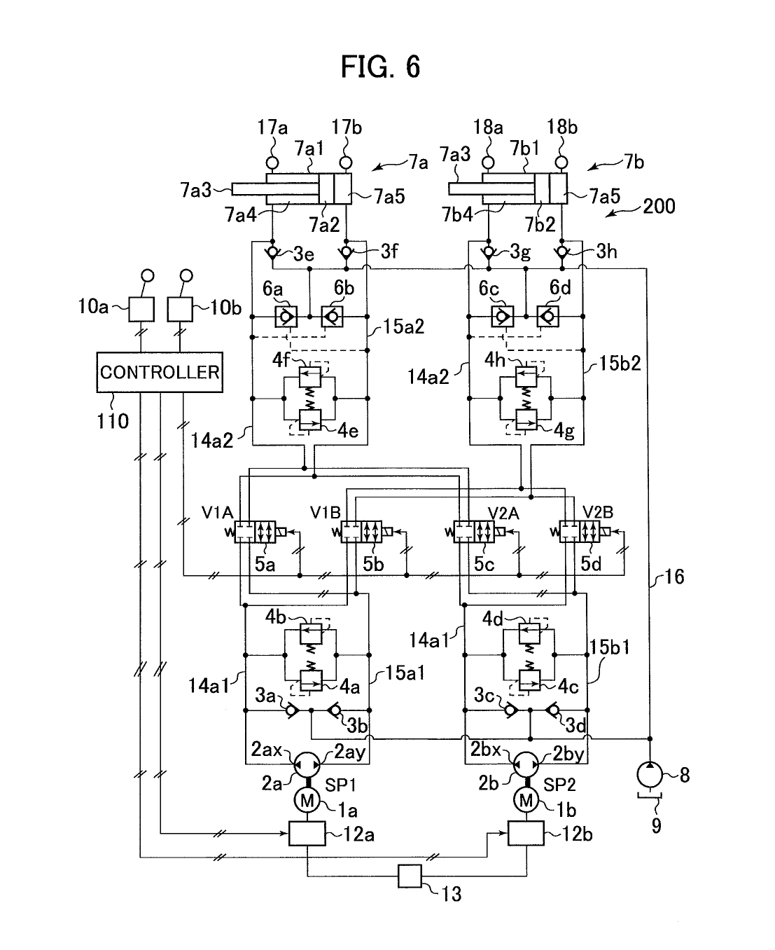

In the following, a second embodiment of the drive system for a hydraulic closed circuit in the present invention will be described with reference to figures. FIG. 6 is a hydraulic circuit diagram showing the second embodiment of the drive system for a hydraulic closed circuit according to the present invention. In this embodiment, an example for driving the arm cylinder 7a and the boom cylinder 7b of the hydraulic excavator is illustrated. Reference characters in FIG. 6 identical to those in FIGS. 1-5 represent components identical to those in FIGS. 1-5, and thus detailed explanation thereof is omitted here.

In the second embodiment shown in FIG. 6, the hydraulic closed circuit 200 is formed basically by provision of two hydraulic closed circuits in the first embodiment and solenoid control valves for switching the connection. Solenoid control valves 5a-5d function to switch the connection between the servo pumps (SP1, SP2) and the cylinders (arm cylinder 7a, boom cylinder 7b). For example, when the solenoid control valve V1A is turned on, the servo pump SP1 and the arm cylinder 7a are connected together.

In FIG. 6, the reference characters 1a and 1b represent first and second electric motors, 2a and 2b represent first and second bidirectional hydraulic pumps, 3a-3d represent first through fourth check valves, 3e-3h represent fifth through eighth check valves, 4a-4d represent first through fourth relief valves, and 4e-4h represent fifth through eighth relief valves. The reference characters 5a and 5b represent first and second solenoid control valves (V1A, V1B) of the 4-port 2-position type, 5c and 5d represent third and fourth solenoid control valves (V2A, V2B) of the 4-port 2-position type, and 6a-6d represent first through fourth pilot check valves. The reference character 7a represents the arm cylinder, 7b represents the boom cylinder, 8 represents a low-pressure pump, 9 represents a tank, 10a represents an arm control lever, 10b represents a boom control lever, 110 represents a controller, 12a and 12b represent inverters, and 13 represents a battery. The first and second electric motors 1a and 1b are driven and rotated by electric power supplied from the battery 13 via the inverters 12a and 12b functioning as delivery flow rate control means. The inverters 12a, 12b supply the first and second electric motors 1a and 1b with electric power corresponding to a drive torque command that is input from the controller 110. In the following explanation, the combination of the first electric motor 1a and the first hydraulic pump 2a will be referred to as a “first servo pump SP1,” and the combination of the second electric motor 1b and the second hydraulic pump 2b will be referred to as a “second servo pump SP2.”

The boom cylinder 7b includes a cylinder body 7b1, a piston 7b2 arranged in the cylinder body 7b1 to be movable, and a piston rod 7b3 arranged on one side of the piston 7b2. A single rod cylinder having a rod-side hydraulic chamber 7b4 and a head-side hydraulic chamber 7b5 is formed of these components.

The low-pressure pump 8 draws in the hydraulic fluid from the tank 9 and supplies low-pressure hydraulic fluid to the delivery line (low-pressure line) 16. The delivery line 16 is connected to the inlet side of the first and second pilot check valves 6a and 6b, the inlet side of the third and fourth pilot check valves 6c and 6d, the inlet side of the first and second check valves 3a and 3b, the inlet side of the third and fourth check valves 3c and 3d, the inlet side of the fifth and sixth check valves 3e and 3f, and the inlet side of the seventh and eighth check valves 3g and 3h.

The first hydraulic pump 2a has two hydraulic fluid discharge and intake ports 2ax and 2ay. A first upstream line 14a1 has one end connected to one hydraulic fluid discharge and intake port 2ax. The other end of the first upstream line 14a1 is joined to either of two upstream connection ports of each of the first solenoid control valve (V1A) 5a and the second solenoid control valve (V1B) 5b. A second upstream line 15a1 has one end connected to the other hydraulic fluid discharge and intake port 2ay. The other end of the second upstream line 15a1 is joined to the other of the two upstream connection ports of each of the first solenoid control valve (V1A) 5a and the second solenoid control valve (V1B) 5b.

The outlet side of the first check valve 3a, allowing the intake only, and the inlet side of the first relief valve 4a, which releases the hydraulic fluid to the second upstream line 15a1 when the pressure in the first upstream line 14a1 reaches a preset pressure or higher, are connected to the first upstream line 14a1. The outlet side of the first relief valve 4a is attached to the second upstream line 15a1. The inlet side of the first check valve 3a is connected to a branch line that is connected to the delivery line 16 of the low-pressure pump 8.

The outlet side of the second check valve 3b, allowing the intake only, and the inlet side of the second relief valve 4b, which releases the hydraulic fluid to the first upstream line 14a1 when the pressure in the second upstream line 15a1 reaches a preset pressure or higher, are connected to the second upstream line 15a1. The outlet side of the second relief valve 4b is connected to the first upstream line 14a1.

A first downstream line 14a2 has one end connected to either of two downstream connection ports of the first solenoid control valve (V1A) 5a. The other end of the first downstream line 14a2 is joined to a connection port of the rod-side hydraulic chamber 7a4 of the arm cylinder 7a. The above downstream connection port of the first solenoid control valve (V1A) 5a is connected to either of two downstream connection ports of the third solenoid control valve (V2A) 5c.

A second downstream line 15a2 has one end connected to the other of the two downstream connection ports of the first solenoid control valve (V1A) 5a. The other end of the second downstream line 15a2 is connected to the connection port of the head-side hydraulic chamber 7a5 of the arm cylinder 7a. The above downstream connection port of the first solenoid control valve (V1A) 5a is connected to the other of the two downstream connection ports of the third solenoid control valve (V2A) 5c.

The outlet side of the fifth check valve 3e, allowing the intake only, the outlet side of the first pilot check valve 6a, allowing the intake only by using the pressure in the second downstream line 15a2 as the pilot pressure, and the inlet side of the fifth relief valve 4e, which releases the hydraulic fluid to the second downstream line 15a2 when the pressure in the first downstream line 14a2 reaches a preset pressure or higher, are connected to the first downstream line 14a2. The outlet side of the fifth relief valve 4e is joined to the second downstream line 15a2. The inlet side of the fifth check valve 3e and the inlet side of the first pilot check valve 6a are joined to a branch line that is connected to the delivery line 16 of the low-pressure pump 8.

The outlet side of the sixth check valve 3f, allowing the intake only, the outlet side of the second pilot check valve 6b, allowing the intake only by using the pressure in the first downstream line 14a2 as the pilot pressure, and the inlet side of the sixth relief valve 4f, which releases the hydraulic fluid to the first downstream line 14a2 when the pressure in the second downstream line 15a2 reaches a preset pressure or higher, are connected to the second downstream line 15a2. The outlet side of the sixth relief valve 4f is connected to the first downstream line 14a2. The inlet side of the sixth check valve 3f and the inlet side of the second pilot check valve 6b are connected to the branch line connected to the delivery line 16 of the low-pressure pump 8.

The second hydraulic pump 2b has two hydraulic fluid discharge and intake ports 2bx and 2by. A third upstream line 14b1 has one end connected to one hydraulic fluid discharge and intake port 2bx. The other end of the third upstream line 14b1 is connected to either of two upstream connection ports of each of the third solenoid control valve (V2A) 5c and the fourth solenoid control valve (V2B) 5d. A fourth upstream line 15b1 has one end connected to the other hydraulic fluid discharge and intake port 2by. The other end of the fourth upstream line 15b1 is joined to the other of the two upstream connection ports of each of the third solenoid control valve (V2A) 5c and the fourth solenoid control valve (V2B) 5d.

The outlet side of the third check valve 3c, allowing the intake only, and the inlet side of the third relief valve 4c, which releases the hydraulic fluid to the fourth upstream line 15b1 when the pressure in the third upstream line 14b1 reaches a preset pressure or higher, are connected to the third upstream line 14b1. The outlet side of the third relief valve 4c is connected to the fourth upstream line 15b1. The inlet side of the third check valve 3c is connected to the branch line connected to the delivery line 16 of the low-pressure pump 8.

The outlet side of the fourth check valve 3d, allowing the intake only, and the inlet side of the fourth relief valve 4d, which releases the hydraulic fluid to the third upstream line 14b1 when the pressure in the fourth upstream line 15b1 reaches a preset pressure or higher, are connected to the fourth upstream line 15b1. The outlet side of the fourth relief valve 4d is connected to the third upstream line 14b1.

A third downstream line 14b2 has one end connected to either of two downstream connection ports of the fourth solenoid control valve (V2B) 5d. The other end of the third downstream line 14b2 is connected to a connection port of the rod-side hydraulic chamber 7b4 of the boom cylinder 7b. The above downstream connection port of the fourth solenoid control valve (V2B) 5d is connected to either of two downstream connection ports of the second solenoid control valve (V1B) 5b.

A fourth downstream line 15b2 has one end connected to the other of the two downstream connection ports of the fourth solenoid control valve (V2B) 5d. The other end of the fourth downstream line 15b2 is connected to the connection port of the head-side hydraulic chamber 7b5 of the boom cylinder 7b. The above downstream connection port of the fourth solenoid control valve (V2B) 5d is connected to the other of the two downstream connection ports of the second solenoid control valve (V1B) 5b.

The outlet side of the seventh check valve 3g, allowing the intake only, the outlet side of the third pilot check valve 6c, allowing the intake only by use of the pressure in the fourth downstream line 15b2 as the pilot pressure, and the inlet side of the seventh relief valve 4g, which releases the hydraulic fluid to the fourth downstream line 15b2 when the pressure in the third downstream line 14b2 reaches a preset pressure or higher, are connected to the third downstream line 14b2. The outlet side of the seventh relief valve 4g is connected to the fourth downstream line 15b2. The inlet side of the seventh check valve 3g and the inlet side of the third pilot check valve 6c are connected to the branch line connected to the delivery line 16 of the low-pressure pump 8.

The outlet side of the eighth check valve 3h, allowing the intake only, the outlet side of the fourth pilot check valve 6d, allowing the intake only by use of the pressure in the third downstream line 14b2 as the pilot pressure, and the inlet side of the eighth relief valve 4h, which releases the hydraulic fluid to the third downstream line 14b2 when the pressure in the fourth downstream line 15b2 reaches a preset pressure or higher, are connected to the fourth downstream line 15b2. The outlet side of the eighth relief valve 4h is connected to the third downstream line 14b2. The inlet side of the eighth check valve 3h and the inlet side of the fourth pilot check valve 6d are connected to the branch line communicating to the delivery line 16 of the low-pressure pump 8.

A part of the cylinder body 7b1 on the rod side of the boom cylinder 7b is equipped with a third pressure sensor 18a (rod-side hydraulic chamber pressure detection means) for detecting the pressure in the rod-side hydraulic chamber 7b4. A part of the cylinder body 7b1 on the head side of the boom cylinder 7b is provided with a fourth pressure sensor 18b (head-side hydraulic chamber pressure detection means) for detecting the pressure in the head-side hydraulic chamber 7a5. The pressures in the hydraulic chambers detected by the third and fourth pressure sensors 18a and 18b are input to the controller 110. The pressures in the hydraulic chambers of the arm cylinder 7a detected by the first and second pressure sensors 17a and 17b are also input to the controller 110.

The boom control lever 10b and the arm control lever 10a are arranged in the cab 33. Operation amount signals from the boom control lever 10b and the arm control lever 10a are input to the controller 110. The controller 110 calculates the switching timing of the first through fourth solenoid control valves 5a-5d and revolution speed commands for the first and second servo pumps SP1 and SP2 on the basis of the operation amount signals and various sensor signals, and then outputs drive command signals to the first through fourth solenoid control valves 5a-5d and the inverters 12a and 12b.

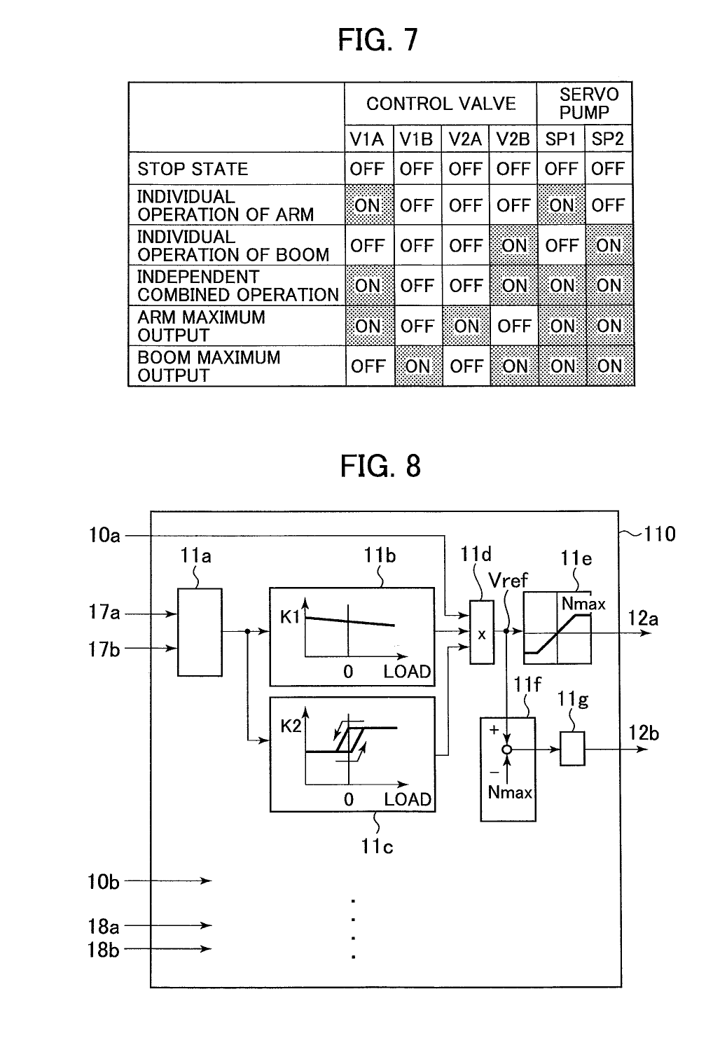

The contents of the calculation of the drive command signals performed by the controller 110 will now be explained below with reference to FIGS. 7 and 8. FIG. 7 is a table showing examples of operations of the solenoid control valves and the servo pumps at times of circuit switching in the second embodiment of the drive system for a hydraulic closed circuit according to the present invention. FIG. 8 is a block diagram showing the contents of the calculation by the controller constituting the second embodiment of the drive system for a hydraulic closed circuit according to the present invention. Reference characters in FIGS. 7 and 8 identical to those in FIGS. 1-6 represent components identical to those in FIGS. 1-6, and thus detailed explanation thereof is omitted here.

FIG. 7 shows the examples of the operations of the solenoid control valves and the servo pumps at times of the circuit switching controlled by the controller 110 in this embodiment.

In the stop state shown in FIG. 7, the controller 110 sets the first through fourth solenoid control valves (V1a-V2B) 5a-5d in a non-excited state while letting the first and second servo pumps SP1 and SP2 be in the stop state. In this condition, the arm cylinder 7a and the boom cylinder 7b due to their own weight can be inhibited from falling since the movement of the hydraulic fluid is blocked by the first through fourth solenoid control valves 5a-5d.

In the individual operation of arm, the controller 110 excites the first solenoid control valve (V1A) 5a while driving the first servo pump SP1. In the individual operation of boom, the controller 110 excites the fourth solenoid control valve (V2B) 5d while driving the second servo pump SP2.

In the combined operation of the boom and arm, the controller 110 excites the first solenoid control valve (V1A) 5a and the fourth solenoid control valve (V2B) 5d while driving the first servo pump SP1 and the second servo pump SP2.

When the growing lever operation amount needs the arm to be operated with the maximum output in the individual operation of arm, the controller 110 excites the third solenoid control valve (V2A) 5c in addition to the first solenoid control valve (V1A) 5a while driving the second servo pump SP2 on top of the first servo pump SP1. Accordingly, hydraulic fluid from both the first and second servo pumps SP1 and SP2 is supplied to the arm cylinder 7a.

Such configuration makes it possible to generate high cylinder output when necessary with downsizing in the capacity of each servo pump. Especially, the capacity of each electric motor can be reduced. The configuration is advantageous when a hydraulic closed circuit has to be installed in a limited space like that in a hydraulic excavator.

FIG. 8 is a block diagram showing a part of the contents of the calculation by the controller 110. FIG. 8 shows a component for outputting command signals to the first and second servo pumps SP1 and SP2 on the basis of the pressures in the hydraulic chambers of the arm control lever 10a and the arm cylinder 7a received as inputs. Although not illustrated here, control blocks for the operation of the boom cylinder 7b are also configured in the same way.

In FIG. 8, the load calculation means 11a, the load sensing means 11b, the load switching means 11c, and the multiplication means 11d have the same functions as those in FIG. 3 explained in the first embodiment. The controller 110 includes output limitation means 11e, subtraction means 11f, and relay means 11g in addition to the above circuits.

The torque command as the output of the multiplication means 11d is assumed here to be a revolution speed command Vref. The torque command (revolution speed command) Vref is input to the output limitation means 11e. The output limitation means 11e has a limitation function of limiting the output to a value corresponding to a preset maximum revolution speed Nmax of the servo pump SP1. This function allows the output limitation means 11e not to output commands greater than the maximum revolution speed Nmax even when the revolution speed command Vref as the input exceeds the maximum revolution speed Nmax. This command signal is output to the inverter 12a that controls the revolution speed of the first electric motor 1a and the first hydraulic pump 2a (first servo pump SP1) on the basis of the command signal.

The revolution speed command Vref and a signal representing the preset maximum revolution speed Nmax of the servo pump SP1 are input to the subtraction means 11f. The subtraction means 11f subtracts the signal of the preset maximum revolution speed Nmax of the servo pump SP1 from the revolution speed command Vref and thereby calculates the surplus of the revolution speed command Vref over the maximum revolution speed Nmax. A signal representing the calculated surplus is output to the relay means 11g.

The relay means 11g receives the surplus signal as an input and includes a relay contact point that becomes ON only at the time of the arm cylinder being in a maximum output operation shown in FIG. 7. That is, the relay means 11g outputs the surplus signal of the revolution speed command Vref as an input with respect to the maximum revolution speed Nmax only when the controller 110 has determined that the current operational status is the arm cylinder maximum output operation. The signal from the relay means 11g is output to the inverter 12b which controls the revolution speed of the second electric motor 1b and the second hydraulic pump 2b (second servo pump SP2) on the basis of this command signal.

Since the command representing the surplus of the revolution speed command Vref relative to the maximum revolution speed Nmax is designed to be issued to the second servo pump SP2 at times of the arm cylinder being in the maximum output operation as explained above, the total flow rate of the servo pumps can be controlled accurately with simple configuration control.

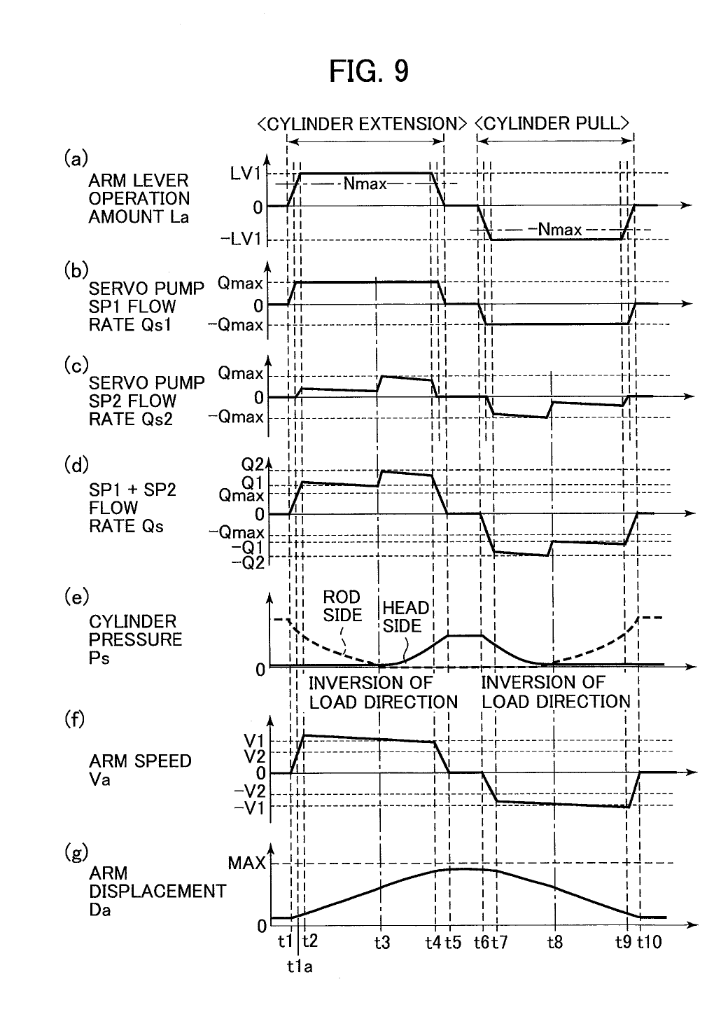

The operation of the second embodiment of the drive system for a hydraulic closed circuit according to the present invention will now be described below with reference to FIG. 9. FIG. 9 is a characteristic diagram showing an example of the relation between the servo pump flow rates, the cylinder pressure, the arm speed, and the arm displacement in the second embodiment of the drive system for a hydraulic closed circuit according to the present invention when the arm cylinder is being driven.

In FIG. 9, the horizontal axis represents the time and the vertical axes (a)-(g) show (from top to bottom) the arm lever operation mount La, the first servo pump flow rate Qs1, the second servo pump flow rate Qs2, the total flow rate Qs of the first servo pump and the second servo pump, the arm cylinder pressure Ps, the arm speed Va, and the arm displacement Da. The graphs from time t1 to time t5 indicate the above characteristics during the extension operation of the piston rod 7a3 in the arm cylinder 7a, whereas the graphs from time t6 to time t10 express the above characteristics during the pull operation of the piston rod 7a3 in the arm cylinder 7a. In this embodiment, the explanation will be given of the case where the operational status is the arm maximum output operation shown in FIG. 7 and the controller 110 excites the third solenoid control valve (V2A) 5c in addition to the first solenoid control valve (V1A) 5a while driving the second servo pump SP2 as well as the first servo pump SP1.

At the time t1, the operator starts operating the arm control lever 10a in the direction of the piston rod 7a3 for an operation amount LV1 by the time t2 being extended. Then, the operation amount of the arm control lever 10a exceeds Nmax at the time t1a. At the time t1a, the load sensing means 11b in FIG. 8 outputs a value 1 or greater as the gain constant K1 and the load switching means 11c in FIG. 8 outputs a value 1 as the gain constant K2. On the basis of the revolution speed commend Vref as the output of the multiplication means 11d, a signal representing the maximum revolution speed Nmax is output via the output limitation means 11e. Accordingly, a flow Qs1 (Qmax) of the hydraulic fluid is delivered from the first servo pump SP1, the hydraulic fluid flows into the head-side hydraulic chamber 7a5 of the arm cylinder 7a, and the piston rod 7a3 in the arm cylinder 7a starts the extension operation.

The revolution speed command Vref as the output of the multiplication means 11d shown in FIG. 8 further rises between the time t1a and the time t2. However, the revolution speed command for the first servo pump SP1 does not change since the command is limited to Nmax by the output limitation means 11e. Meanwhile, the functions of the subtraction means 11f and the relay means 11g have a surplus signal of the revolution speed command Vref relative to the maximum revolution speed Nmax to be output to the second servo pump SP2. A flow of the hydraulic fluid corresponding to the surplus is accordingly delivered from the first servo pump SP1. Consequently, the total flow rate Qs of the first servo pump and the second servo pump becomes Q1 or higher as shown in FIG. 9(d) and the total flow of the hydraulic fluid flows into the head-side hydraulic chamber 7a5 of the arm cylinder 7a.

At this point, the first solenoid control valve (V1A) 5a and the third solenoid control valve (V2A) 5c shown in FIG. 6 are in the excited state, and thus the rod-side hydraulic chamber 7a4 (high pressure) of the arm cylinder 7a, the first downstream line 14a2, the first upstream line 14a1 and the third upstream line 14b1 are connected together. Similarly, the head-side hydraulic chamber 7a5 (low pressure) of the arm cylinder 7a, the second downstream line 15a2, the second upstream line 15a1, and the fourth upstream line 15b1 communicate with each other.

Since the rod-side hydraulic chamber 7a4 is at high pressures, the first check valve 3a (connected to the first upstream line 14a1), the third check valve 3c (connected to the third upstream line 14b1), and the first pilot check valve 6a and the fifth check valve 3e (connected to the first downstream line 14a2) are closed. Accordingly, the entire flow of the hydraulic fluid from the rod-side hydraulic chamber 7a4 is drawn into the hydraulic fluid discharge and intake port 2ax of the first hydraulic pump 2a and the hydraulic fluid discharge and intake port 2bx of the second hydraulic pump 2b. At this time, the flow rate becomes insufficient since the intake flow rate of the first and second hydraulic pumps 2a and 2b is lower than the required delivery flow rate of the hydraulic pumps 2a and 2b due to the capacity difference between the cylinder head-side hydraulic chamber 7a5 and the cylinder rod-side hydraulic chamber 7a4. However, the shortfall of the hydraulic fluid flow is supplied from the low-pressure pump 8 via the low-pressure line 16 and is drawn into the second downstream line 15a2 by way of the release operation with the second pilot check valve 6b and the sixth check valve 3f, into the second upstream line 15a1 by way of the release operation with the second check valve 3b, and into the fourth upstream line 15b1 by way of the release operation with the fourth check valve 3d.

The arm 36 rotates downward due to the above-described extension of the piston rod 7a3 in the arm cylinder 7a. At the point (time t3) when the axial direction of the arm 36 exceeds the substantially perpendicular line extending downward from the center of the axis of the tip end part of the boom 35 supporting the arm 36, the direction of the cylinder load F on the arm cylinder 7a inverts. The gain constant K1 equals 1 at the time t3 because of the characteristics of the load sensing means 11b shown in FIG. 8. The total flow rate Qs of the hydraulic fluid equals Q1 and the speed of the piston rod 7a3 in the arm cylinder 7a equals V1 at the time t3. Incidentally, the operator holds the arm control lever 10a at the operation amount LV1 till the time t4 and then returns the operation amount to 0 in the period from the time t4 to the time t5.

Meanwhile, between the time t3 and the time t4, the second check valve 3b connected to the second upstream line 15a1, the fourth check valve 3d connected to the fourth upstream line 15b1, and the second pilot check valve 6b and the sixth check valve 3f connected to the second downstream line 15a2 are closed since the head-side hydraulic chamber 7a5 shown in FIG. 6 is at high pressures. Accordingly, the entire flow Qs of the hydraulic fluid delivered from the first servo pump SP1 and the second servo pump SP2 flows into the head-side hydraulic chamber 7a5. At this time, the flow rate becomes insufficient since the total intake flow rate of the first hydraulic pump 2a and the second hydraulic pump 2b is lower than the total required delivery flow rate of the hydraulic pumps 2a and 2b due to the capacity difference between the cylinder head-side hydraulic chamber 7a5 and the cylinder rod-side hydraulic chamber 7a4. However, the shortfall of the hydraulic fluid flow is supplied from the low-pressure pump 8 via the low-pressure line 16 and is drawn into the first downstream line 14a2 by the release operation with the first pilot check valve 6a and the fifth check valve 3e, into the first upstream line 14a1 by the release operation with the first check valve 3a, and into the third upstream line 14b1 by the release operation with the third check valve 3c. The insufficiency of the flow rate is consequently compensated for.

The inversion of the direction of the cylinder load F causes the load switching means 11c shown in FIG. 8 to output a value 1.3, for example, as the gain constant K2. Thus, the revolution speed command Vref as the output of the multiplication means 11d expands. Since the command for the first servo pump SP1 is limited to Nmax by the output limitation means 11e as explained above, the command for the second servo pump SP2 increases. Accordingly, a flow of the hydraulic fluid corresponding to the total flow rate Qs (Q2) of the first servo pump SP1 and the second servo pump SP2 flows into the head-side hydraulic chamber 7a5 of the arm cylinder 7a and the piston rod 7a3 in the arm cylinder 7a continues the extension operation. In other words, the decline in the speed of the piston rod 7a3 in the arm cylinder 7a is prevented by the increase in the flow rate Qs of the servo pump SP1 with respect to that before the load direction inversion. The flow rate Qs of the servo pump SP1 at the time t3 is Q2 and that at the time t4 is lower than Q2, which is due to the characteristics of the load sensing means 11b.

A sharp change in the arm speed can be averted by the increase in the total flow rate Qs of the first and second servo pumps SP1 and SP2 from Q1 to Q2 at the time of the load direction inversion as explained above. The flow rate Q2 of the hydraulic fluid is a value raised from Q1 by the ratio between the pressure-receiving areas in the cylinder. In other words, the flow rate Q2 is calculated as Q2=Q1*Ahead/Arod. The use of the load sensing means 11b raises the pressure in the head-side hydraulic chamber 7a5, as well as the cylinder load F. This causes the reduction in the total flow rate Qs of the first and second servo pumps SP1 and SP2, which leads to the lower arm speed. The natural operational feeling can be thereby realized as a result of the speed degradation.

The load sensing means 11b and the load switching means 11c perform similar control on the pull operation of the piston rod 7a3. The speed of the piston rod 7a3 in the arm cylinder 7a in accordance with the cylinder load F can be obtained smoothly as a result without the speed fluctuation at times of the load inversion. According to this embodiment, high-speed and high-power driving of the piston rod 7a3 by means of the combination of the delivery flow rates of a plurality of pumps, and high operability can be achieved at the same time.

Although the total flow rate in this embodiment is modified by adjustment of the flow rate of the second servo pump SP2 while the flow rate of the first servo pump SP1 is fixed at Qmax, the method of the control is not restricted to this example; both the flow rates of the first and second servo pumps SP1 and SP2 may be changeable.

Advantages similar to the aforementioned effects of the first embodiment can be obtained according to the above-described second embodiment of the drive system for a hydraulic closed circuit in the present invention.

Further, even in cases where the piston rod of one cylinder is driven by a plurality of hydraulic pumps, the speed fluctuation of a piston rod in a cylinder at times of the load inversion can be suppressed according to the above-described second embodiment of the drive system for a hydraulic closed circuit in the present invention. This makes it possible to realize high-speed and high-power driving of a work implement and high operability at the same time, which increases the productivity as a result.

### Third Embodiment

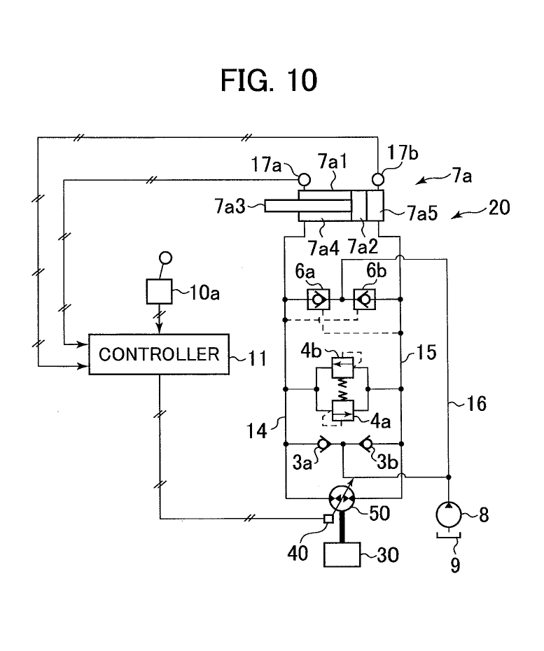

In the following, a third embodiment of the drive system for a hydraulic closed circuit according to the present invention will be described with reference to a figure. FIG. 10 is a hydraulic circuit diagram showing the third embodiment of the drive system for a hydraulic closed circuit according to the present invention. Reference characters in FIG. 10 identical to those in FIGS. 1-9 represent components identical to those in FIGS. 1-9, and thus detailed explanation thereof is omitted here.

In this embodiment, the delivery flow rate control means differs from that in the first embodiment although the hydraulic circuit is substantially the same. In the first embodiment, the delivery flow rate control means is configured to control the pump delivery flow rate of the bidirectional hydraulic pump 2 by performing the variable speed control on the electric motor 1 by using the inverter 12. In this embodiment, the inverter 12 and the electric motor 1 are left out.

In FIG. 10, the reference character 50 represents a variable bidirectional hydraulic pump, 30 represents an engine which drives the variable bidirectional hydraulic pump 50, and 40 represents a hydraulic regulator which controls the swash plate tilt angle of the variable bidirectional hydraulic pump 50.

The controller 11 calculates the command signal by performing calculations similar to those in the first embodiment and outputs the calculated command signal to the hydraulic regulator 40. The variable bidirectional hydraulic pump 50, undergoing the control of its swash plate tilt angle by the hydraulic regulator 40, changes its delivery flow rate in accordance with the control.

Advantages similar to the aforementioned of the first embodiment can be achieved according to the above-described third embodiment of the drive system for a hydraulic closed circuit according to the present invention.

### Fourth Embodiment

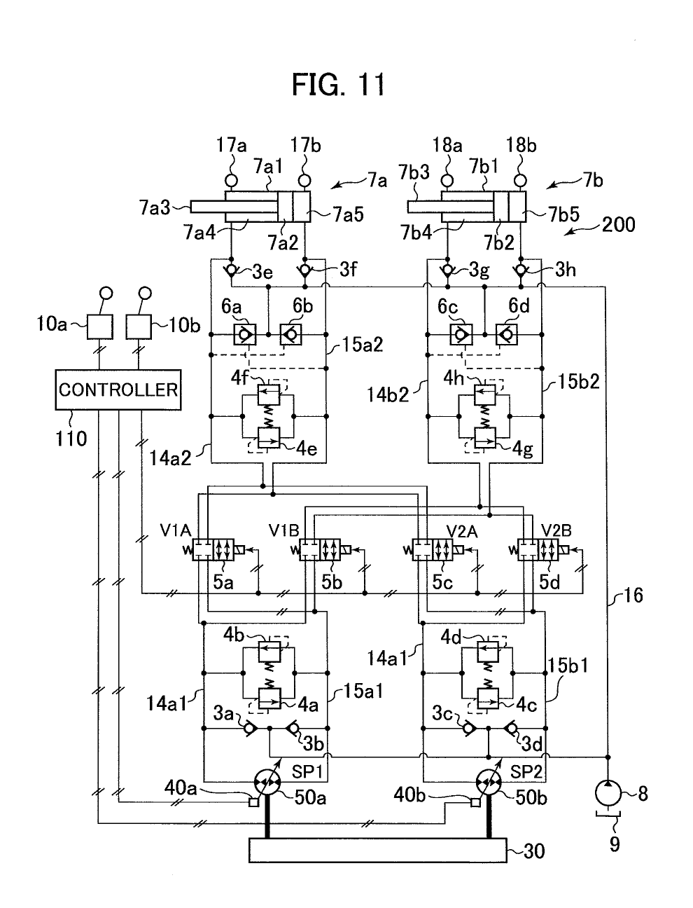

In the following, a fourth embodiment of the drive system for a hydraulic closed circuit according to the present invention will be described with reference to a figure. FIG. 11 is a hydraulic circuit diagram showing the fourth embodiment of the drive system for a hydraulic closed circuit according to the present invention. Reference characters in FIG. 11 identical to those in FIGS. 1-10 represent components identical to those in FIGS. 1-10, and thus detailed explanation thereof is omitted here.

In this embodiment, the delivery flow rate control means differs from that in the second embodiment although the hydraulic circuit is substantially the same. In the second embodiment, the delivery flow rate control means is configured to control the pump delivery flow rates of the bidirectional hydraulic pumps 2a and 2b by performing the variable speed control on the electric motors 1a and 1b by use of the inverters 12a and 12b. In this embodiment, the inverters 12a and 12b and the electric motors 1a and 1b are left out.

In FIG. 11, the reference characters 50a and 50b represent variable bidirectional hydraulic pumps, the reference character 30 represents an engine which drives the variable bidirectional hydraulic pumps 50a and 50b, and the reference characters 40a and 40b represent hydraulic regulators which respectively control the swash plate tilt angles of the variable bidirectional hydraulic pumps 50a and 50b.

The controller 110 calculates the command signals by performing calculations similar to those in the second embodiment and outputs the calculated command signals to the hydraulic regulators 40a and 40b. The variable bidirectional hydraulic pumps 50a and 50b, undergoing the control of their swash plate tilt angles by the hydraulic regulators 40a and 40b, change their delivery flow rates in accordance with the control.

Advantages similar to the aforementioned of the first embodiment can be achieved according to the above-described fourth embodiment of the drive system for a hydraulic closed circuit in the present invention.

While examples employing pilot check valves as flow rate difference absorption means in the hydraulic closed circuit have been described in the above embodiments, the configuration of the hydraulic closed circuit is not restricted to such examples. For example, the hydraulic closed circuit may also be configured to carry out the flow rate difference absorption by use of low-pressure selection valves, such as flushing valves and shuttle valves or solenoid valves.

### DESCRIPTION OF REFERENCE CHARACTERS

1 electric motor
2 hydraulic pump (bidirectional hydraulic pump)
3a first check valve
3b second check valve
4a first relief valve
4b second relief valve
5a first solenoid control valve
5b second solenoid control valve
5c third solenoid control valve
5d fourth solenoid control valve
6a first pilot check valve
6b second pilot check valve
7a arm cylinder (single rod cylinder)
7b boom cylinder (single rod cylinder)
8 low-pressure pump
9 tank
10a arm control lever (operating device)
11 controller (control device)
11a load calculation means
11b load sensing means
11c load switching means
11d multiplication means
11e output limitation means
11f subtraction means
12 inverter (delivery flow rate control means)
13 battery
14 first line
15 second line
17a pressure sensor (rod-side hydraulic chamber pressure detection means)
17b pressure sensor (head-side hydraulic chamber pressure detection means)
18a pressure sensor (rod-side hydraulic chamber pressure detection means)
18b pressure sensor (head-side hydraulic chamber pressure detection means)
20 hydraulic closed circuit
30 engine
40 hydraulic regulator (delivery flow rate control means)
50 hydraulic pump (variable bidirectional hydraulic pump)
110 controller (control device)
200 hydraulic closed circuit
SP1 servo pump
SP2 second servo pump

1. A drive system for a hydraulic closed circuit, comprising:
a bidirectional hydraulic pump;
delivery flow rate control means which controls a delivery flow rate of the bidirectional hydraulic pump;
a single rod cylinder driven by hydraulic fluid delivered from the bidirectional hydraulic pump;
a first line having an end connected to one discharge port of the bidirectional hydraulic pump and the other end connected to a rod-side hydraulic chamber of the single rod cylinder;
a second line having an end connected to the other discharge port of the bidirectional hydraulic pump and the other end connected to a head-side hydraulic chamber of the single rod cylinder; and
an operating device for commanding driving of the single rod cylinder, wherein the drive system further comprises:
rod-side hydraulic chamber pressure detection means which detects pressure in the rod-side hydraulic chamber of the single rod cylinder;
head-side hydraulic chamber pressure detection means which detects pressure in the head-side hydraulic chamber of the single rod cylinder; and
a control device including:
load calculation means which calculates load on the single rod cylinder on a basis of the pressure in the rod-side hydraulic chamber of the single rod cylinder detected by the rod-side hydraulic chamber pressure detection means and the pressure in the head-side hydraulic chamber of the single rod cylinder detected by the head-side hydraulic chamber pressure detection means;
load switching means which calculates a first proportional gain in accordance with a polarity of the load calculated by the load calculation means; and
multiplication means which calculates a command signal by multiplying the first proportional gain calculated by the load switching means and an operation amount input from the operating device, and outputs the calculated command signal to the delivery flow rate control means.

2. The drive system for a hydraulic closed circuit according to claim 1, wherein the load calculation means calculates the load on the single rod cylinder by subtracting a product of the pressure in the rod-side hydraulic chamber of the single rod cylinder detected by the rod-side hydraulic chamber pressure detection means and the pressure-receiving area on the cylinder rod side of the single rod cylinder from a product of the pressure in the head-side hydraulic chamber of the single rod cylinder detected by the head-side hydraulic chamber pressure detection means and the pressure-receiving area on the cylinder head side of the single rod cylinder.

3. The drive system for a hydraulic closed circuit according to claim 2, wherein output characteristics of the first proportional gain that is output by the load switching means have a dead zone or hysteresis in a region where the polarity of the load on the single rod cylinder changes.

4. The drive system for a hydraulic closed circuit according to claim 1, comprising a control device including:
load sensing means which calculates a second proportional gain that gradually decreases with increase in the load calculated by the load calculation means; and
multiplication means which calculates a command signal by multiplying the first proportional gain calculated by the load switching means, the second proportional gain calculated by the load sensing means, and the operation amount that is input from the operating device and outputs the calculated command signal to the delivery flow rate control means.

5. A drive system for a hydraulic closed circuit, comprising:
a plurality of bidirectional hydraulic pumps;
a plurality of delivery flow rate control means which control a delivery flow rate of the bidirectional hydraulic pumps;
a plurality of single rod cylinders driven by hydraulic fluid delivered from the bidirectional hydraulic pumps;
a plurality of control valves which enable connection between either a rod-side hydraulic chamber or a head-side hydraulic chamber of one of the single rod cylinders and a discharge port of one or two of the bidirectional hydraulic pumps, and connection between the other of the rod-side hydraulic chamber or the head-side hydraulic chamber of the one of the single rod cylinders and the other discharge port of the one or two of the bidirectional hydraulic pumps;
a plurality of operating devices for commanding the driving of the single rod cylinders, wherein the drive system comprises:
rod-side hydraulic chamber pressure detection means which detects the pressure in the rod-side hydraulic chamber of each of the single rod cylinders;
head-side hydraulic chamber pressure detection means which detects the pressure in the head-side hydraulic chamber of each of the single rod cylinders; and
a control device including:
load calculation means which calculates the load on each of the single rod cylinders on the basis of the pressure in the rod-side hydraulic chamber of each of the single rod cylinders detected by the rod-side hydraulic chamber pressure detection means and the pressure in the head-side hydraulic chamber of each of the single rod cylinders detected by the head-side hydraulic chamber pressure detection means;
load switching means which calculates each first proportional gain according to the polarity of the load on each of the single rod cylinders calculated by the load calculation means; and
multiplication means which calculates each command signal by multiplying each first proportional gain calculated by the load switching means and an operation amount input from each operating device together and outputs each calculated command signal to each delivery flow rate control means.

6. The drive system for a hydraulic closed circuit according to claim 5, comprising a control device including:
output limitation means which limits the output of the multiplication means to a preset command value and outputs the limited signal as the command signal to one delivery flow rate control means corresponding to one of the bidirectional hydraulic pumps; and
subtraction means which subtracts the preset command value from the output of the multiplication means and outputs a signal calculated by the subtraction as the command signal to one delivery flow rate control means corresponding to another one of the bidirectional hydraulic pumps.

7. The drive system for a hydraulic closed circuit according to claim 2, comprising a control device including:
load sensing means which calculates a second proportional gain that gradually decreases with increase in the load calculated by the load calculation means; and
multiplication means which calculates a command signal by multiplying the first proportional gain calculated by the load switching means, the second proportional gain calculated by the load sensing means, and the operation amount that is input from the operating device and outputs the calculated command signal to the delivery flow rate control means.

8. The drive system for a hydraulic closed circuit according to claim 3, comprising a control device including:
load sensing means which calculates a second proportional gain that gradually decreases with increase in the load calculated by the load calculation means; and
multiplication means which calculates a command signal by multiplying the first proportional gain calculated by the load switching means, the second proportional gain calculated by the load sensing means, and the operation amount that is input from the operating device and outputs the calculated command signal to the delivery flow rate control means.
